(19) United States
(12) Patent Application Publication
(10) Pub. No.: US 2004/0041134 A1
(43) Pub. Date: Mar. 4, 2004

(54) Engine removal / replacement apparatus & method

(75) Inventor: Ray Baker, Wilmington, OH (US)

Correspondence Address: Joseph G. Nauman, 696 Renolda Woods Ct., Dayton, OH, 45429-3415, US

(73) Assignee: Steck Manufacturing Company, Inc.

(21) Appl. No.: 10/651,860

(22) Filed: Aug. 29, 2003

Related U.S. Application Data
(60) Provisional application No. 60/407,037, filed on Aug. 30, 2002.

(51) Int. Cl. B66F 3/00

(52) U.S. Cl. 254/8 B

(57) ABSTRACT

An appropriate engine plate, having a bolt hole pattern to match a hole pattern in an engine in a front engine van type vehicle, is attached to an adapter arm tube attachable to the arm (e.g. boom) of a conventional engine floor hoist. One end of the adapter arm tube is telescopically fitted onto the hoist arm, and the other tube end has a pair of spaced apart forwardly extending hinge plates that define a horizontal attachment axis. The engine plates have socket-like hinge plates which can be connected with hinge pins to the adapter hinge plates of the adapter arm, providing a horizontally aligned hinge attachment between the engine and the hoist arm. The tilt angle of the engine plate and an attached engine is adjustable by a tilt control in the form of an extendable/retractable shaft which acts between the hoist adapter arm and a region of the engine, such as the crankshaft pulley, vertically spaced from the horizontal hinge axis of the attached engine adapter plate. As the hoist lifts an attached engine free of its detached mounts, and is withdrawn from the vehicle, the tilt control can be manipulated to avoid contact with the surrounding parts of the engine compartment until the engine is completely separated from the vehicle.

### RELATED APPLICATIONS

This application is based upon and claims the priority of U.S. Provisional Application Ser. No. 60/407,037 filed Aug. 30,2002.

### BACKGROUND OF THE INVENTION

When removing the engine from a rear wheel drive van there is no clearance to lift the engine with an engine hoist. The present procedure requires removing the radiator(s) and their coolant and/or oil cooling hoses and lines, then removing the fuel injector system or carburetor, and (often) all sorts of other peripheral items that are difficult to access within the limited space of the engine compartment in the van-type vehicles. It is much preferred not to have to perform this labor at that point. Also present practice then requires entering the boom of an engine hoist just above the intake manifold, and attaching a chain around the engine and the boom as tight as possible. Hopefully one can probably get the engine out at that point, but it may first also be necessary to remove the engine intake manifold. As more ‘peripheral’ parts are required to be removed first, the lapsed time for the operation extends rapidly; all of these involve reaching into the crowded engine compartment from the front or through the internal hatch, and use of power tools is considerably impeded or impossible.

When major engine repairs or replacement are needed in such van-type vehicles it would be much more efficient to minimize removal of the engine peripherals before pulling the engine out, but the close fit and minimal size of the engine compartment, even with the radiator removed, the short hood open, and the upper cross piece that supports the top of the radiator removed, makes pulling out the entire engine a difficult if not impossible task.

### SUMMARY OF THE INVENTION

To remove the same engine using the apparatus and method of the present invention, all or most of the engine peripheral parts can be left on the engine while the engine is extracted, to make it easier to transfer such parts to a new engine (or a refurbished ‘short block’) once the engine is out of the van. The transmission can be disconnected from the engine or the drive shaft-to-transmission coupling can be separated; in the latter case the engine-transmission combination may be withdrawn; this is a choice for the mechanic. Using this invention, it is not necessary to remove parts from inside the van; this alone can save hours.

The removal, from the frontal exterior, of the radiator, fan, and hoses, the cross piece holding the radiator top, and the front bumper, are still necessary but there is no spatial impediment to using power tools for those tasks. Then, after separating the transmission from the engine (or the front of the drive shaft from the transmission), the mechanic instead just releases the engine mounts, unbolts and removes the water pump at the exposed front of the engine, and then bolts a special engine plate (part of the provided apparatus) to the same water pump mounting holes. Appropriate plates to fit different engines (e.g. Chevrolet / GM, Ford, and/or Dodge/Chrysler, either V-8 or 6-cylinder engines) are provided.

The appropriate engine plate is attached to an adapter arm tube, a further element of the apparatus that can be accepted by the arm (e.g. boom) of a conventional engine floor hoist. One end of the adapter arm tube is received (preferably telescopically) on or in the hoist arm, and the other tube end has a pair of spaced apart forwardly extending hinge plates that define a horizontal attachment axis The hoist boom normally has sets of transverse holes to receive locator cross-pins, thus facilitating attachment of the adapter arm tube to the desired location on the boom.

The engine plates have socket-like hinge plates which can be connected with hinge pins to the adapter hinge plates of the adapter arm. This arrangement provides a horizontally aligned hinge attachment between the engine (once the engine plate is bolted to it) and the hoist arm.

To control the tilt angle of the engine plate (and the attached engine), an adjustable tilt control is provided, preferably in the form of an extendable/retractable shaft similar to a turnbuckle, which acts between the hoist adapter arm (or the hoist arm itself) and a region of the engine, such as the crankshaft pulley, below the attached engine adapter plate. As the hoist with the attached engine lifts the engine free of its detached mounts, and is moved away from the vehicle, the tilt control can be manipulated to avoid contact with the surrounding parts of the engine compartment until the engine is completely separated (withdrawn) from the vehicle. The hoist can then be used to place the engine on a conventional engine stand for easy removal of the engine peripheral parts, as necessary, using power tools, etc. (if desired) which would not fit into the engine compartment with the engine therein.

The invention can also b used to insert a repaired engine into a van-type vehicle, simply by reversing the steps of removal.

Other objects and advantages of the invention will be apparent from the following description and the accompanying drawings.

### BRIEF DESCRIPTION OF THE DRAWINGS

FIG. 1 is a pictorial view of a 6-cylinder engine (straight six) in the front engine compartment of a van-type vehicle, with the front bumper, coolant radiator and its upper support bracket, and the hinged engine hood removed;

FIG. 2A is a pictorial view of the front of a V-8 engine with the water pump still attached, and FIG. 2B is the same view with the water pump removed;

FIG. 3 is a pictorial view of the front of the engine shown in FIGS. 2A & 2B with an engine adapter plate attached;

FIG. 4 is a pictorial view of the items, partially assembled, comprising the apparatus provided by the invention;

FIG. 5 is a pictorial view of the apparatus mounted to the boom arm of an engine hoist and carrying the engine as shown in FIG. 3.

### DESCRIPTION OF THE PREFERRED EMBODIMENT

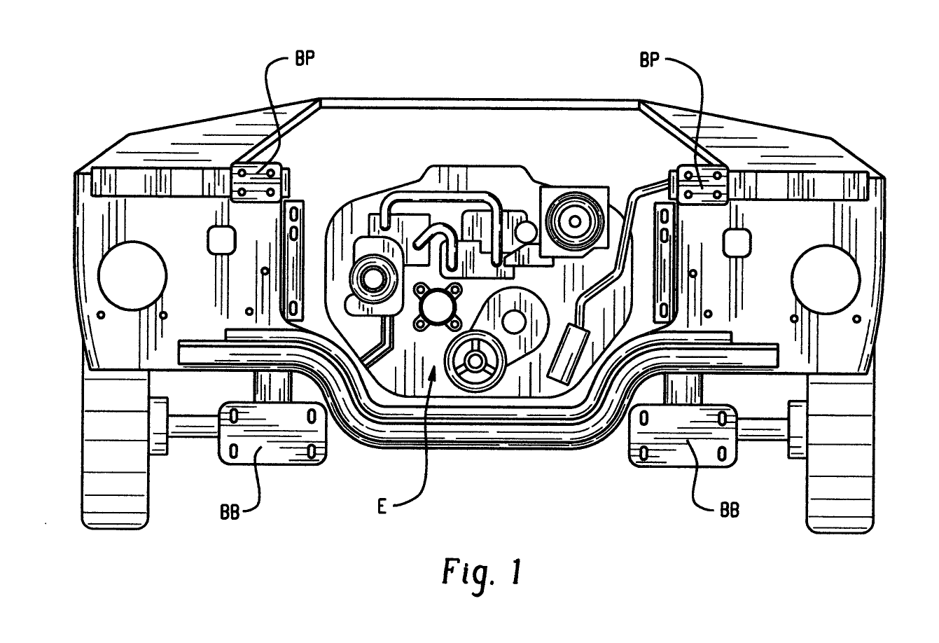

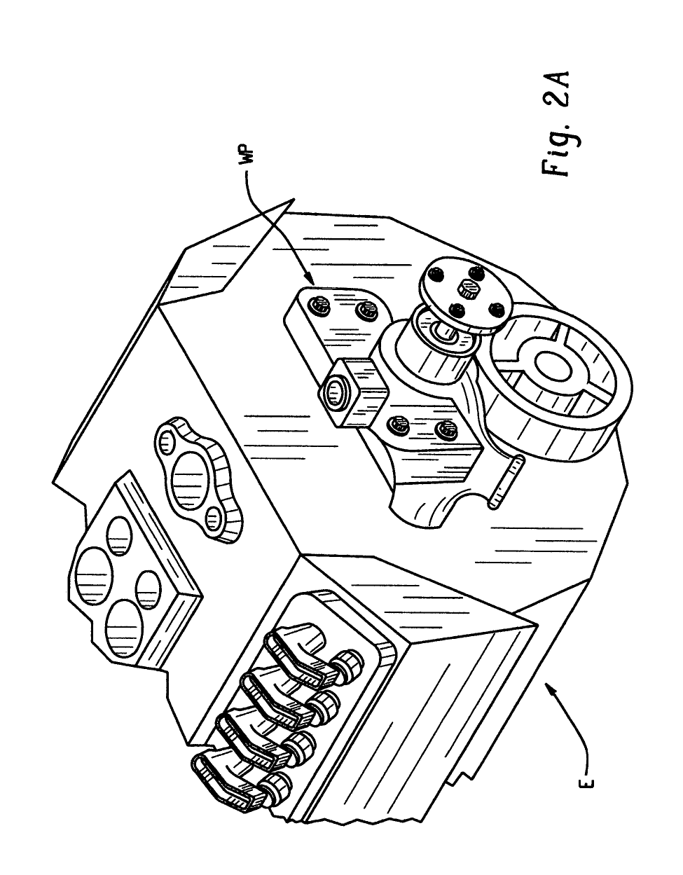

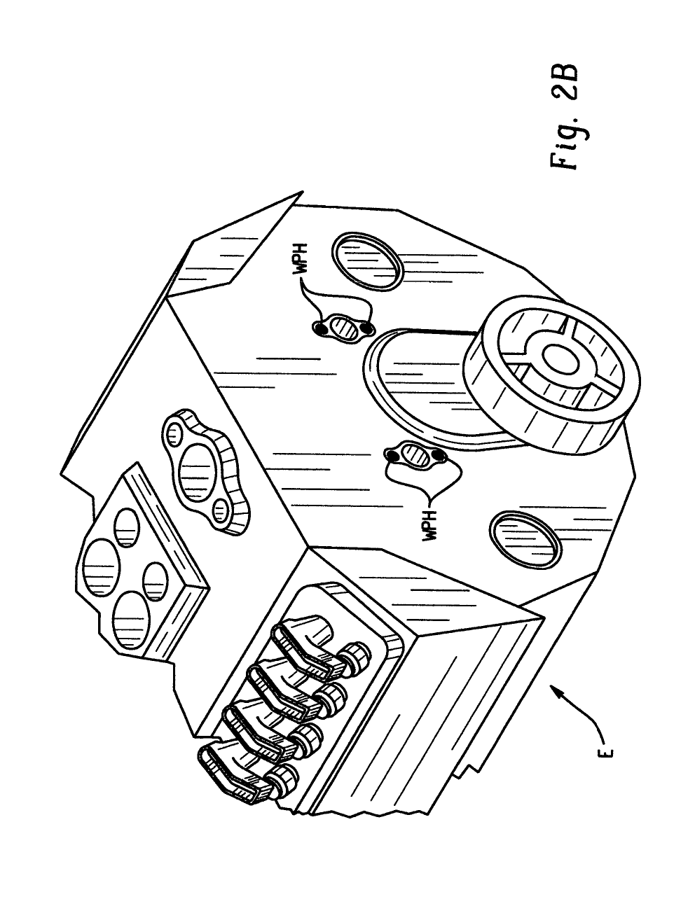

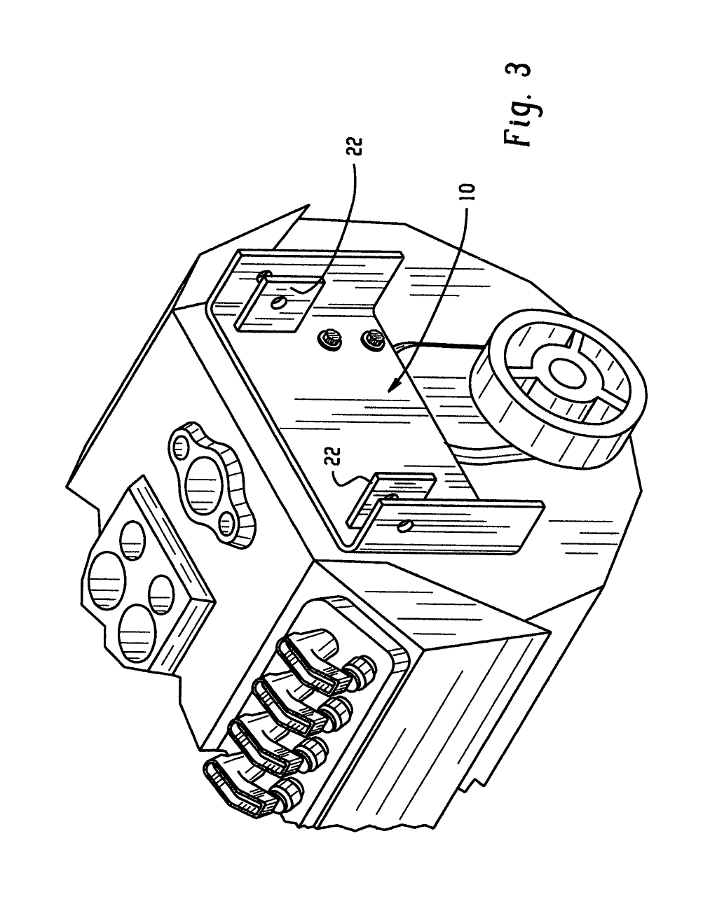

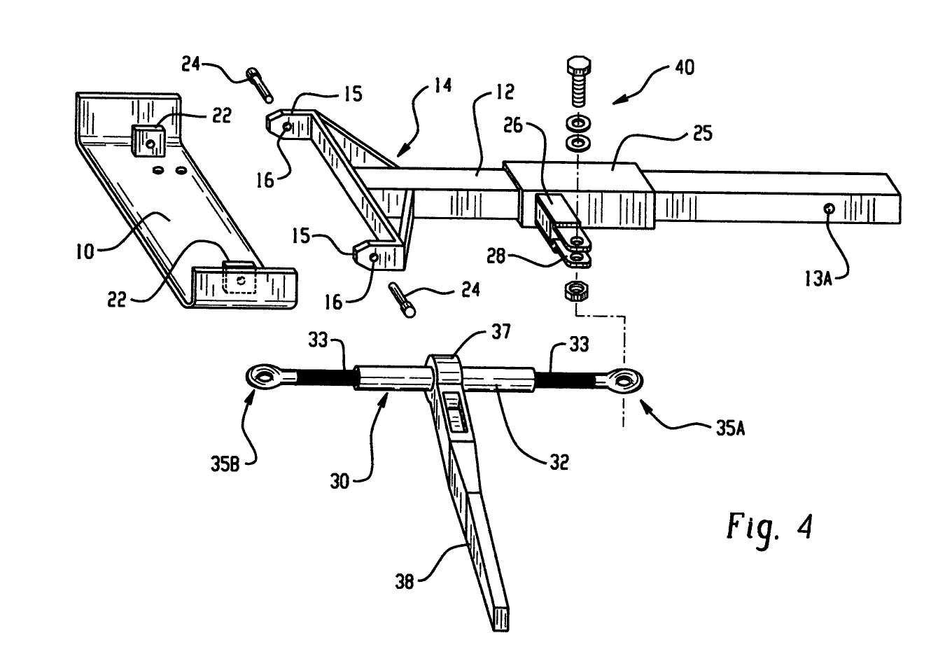

Referring to the drawings, to remove an engine from a van-type vehicle, using the apparatus of the present invention, all or most of the engine peripheral parts can be left on the engine while the engine is extracted. To prepare for frontal extraction of the engine, once the front bumper is removed (note bumper brackets BB in FIG. 1), radiator(s) and attached hoses and/or pipes (not shown) are removed, along with the upper radiator mount cross-bar (note bracket pads BP). Then the mechanic just unbolts and removes the water pump WP (FIGS. 2 & 3)at the exposed front of the engine E, and then bolts a special engine plate 10 to the same water pump mounting holes WPH (FIG. 4). Plate 10 is uniquely designed with a bolt hole pattern that fits the water pump mounting holes.

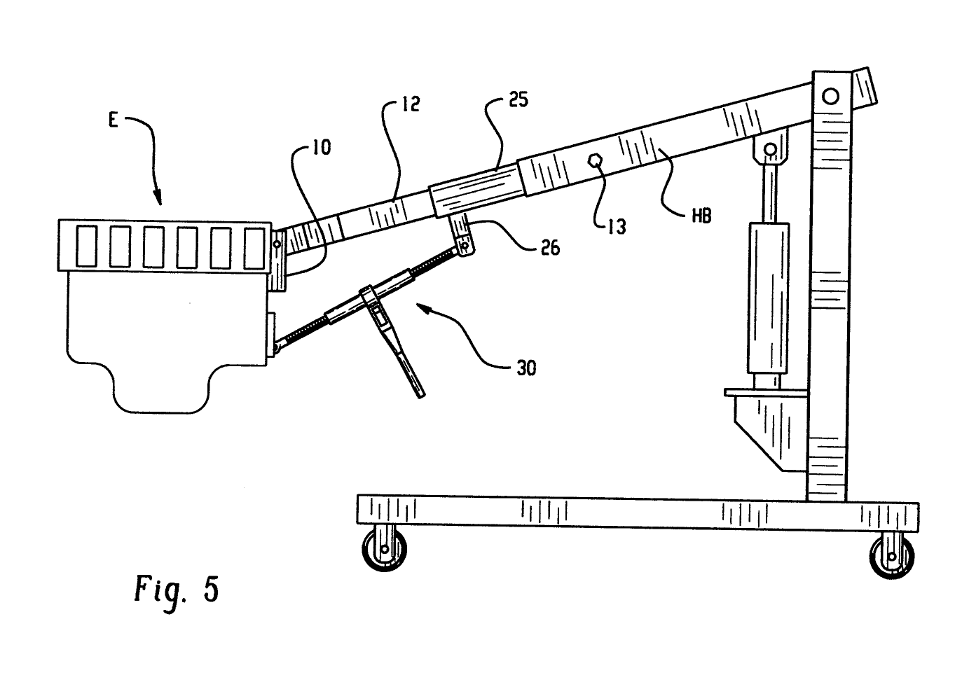

This engine plate 10 is attached to an adapter assembly including arm tube 12 (normally a tube with a square cross-section). One end (rear) of tube 12 is fitted (preferably telescopically) on or into the hoist arm (boom) HB (FIG. 5) and pinned in place, as by a bolt 13 which extends through a hole 13A in tube 12 (see FIG. 4). The other (forward) end 14 of tube 12 has a pair of spaced apart forward extending adapter hinge plates 15 having holes 16 therein which define a horizontal attachment axis. The engine plate 10 has socket-like plates 22 which can be connected with hinge pins 24 to the hinge plates 15 of the adapter arm. This arrangement provides a horizontally aligned hinge attachment between the engine (once the engine plate is bolted to it) and the hoist arm HA (FIG. 5). The engine plate and adaptor plate may be more permanently hinged together, however better flexibility of use is available if the engine plate can be independently fastened to the engine before the hoist with adapter is attached.

To control the tilt angle of the engine E, plate 10 (and its attached engine E), an adjusting mechanism (leveler control) is provided in the form of a tensioning tube 25 (FIGS. 4 & 5) is fitted over adapter arm tube 12 and has a depending arm 26, fixed to tube 25 and extending outwardly therefrom, with a clevis 28 at its end. A relatively large turnbuckle 30, including a central body 32 with oppositely threaded sockets 33, each socket having an appropriately threaded eye-bolt 35A and 35B. This provides and extendable/retractable adjusting shaft. Attached to the central body 32 is a reversible ratchet mechanism 37 with a handle 38 which can cause central body 32 to rotate in either of two opposite directions, and thus to draw inward, or force outward, the eye-bolts 35A, 35B. One eye-bolt 35A is secured to clevis 28 with a machine bolt 40, and the other eyebolt 35B is used to press against engine E, for example against the crankshaft pulley P (see FIG. 5).

### Method of Removing/Replacing Engine

1. The front of the vehicle having the previously mentioned frontal parts removed, and an engine plate 10 attached to the front of the engine block, the mechanic brings the hoist arm (boom) tip to the opened engine compartment, at the van front, and inserts the pivot pin 24, joining the adapter plate 15 to the engine plate 10;

2. Insert the free end of eye-bolt 35B of the leveler control into the engine pulley and insert bolt 40 through the clevis 28 and eye of eye-bolt 35A;

3. Adjust the leveler control ratchet so there is some tension against the engine;

4. Raise the hoist just enough to clear the engine mounts, which have been released;

5. Slide the engine out slowly through the frontal opening in the vehicle, while adjusting the leveler control or the hoist as necessary to miss any obstructions.

These steps can be performed in a matter of minutes, Once the engine is out of the van it may be

a) suspended for parts removal, or

b) easily transferred to an engine stand.

A new or rebuilt engine can be attached to the apparatus and the process reversed.

While the method herein described, and the form of apparatus for carrying this method into effect, constitute preferred embodiments of this invention, it is to be understood that the invention is not limited to this precise method and form of apparatus, and that changes may be made in either without departing from the scope of the invention.

What is claimed is:

1. The method of removing an engine from a van type vehicle, the front of the vehicle having external frontal parts removed to create a large frontal opening in the vehicle within which the front of the engine is exposed and through which the engine may be extracted, comprising the steps of:
a. attaching an engine plate to the front of the engine block;
b. attaching an adapter tube with an adapter plate to a hoist arm and moving the hoist to locate the adapter plate at the opened engine compartment;
c. joining the adapter plate to the engine plate with a pivot pin;
d. placing the free end of a leveler control attached to the adapter tube against the engine spaced vertically from the pivot pin;
e. adjusting the leveler control ratchet to place the leveler shaft in tension against the engine;
f. releasing the engine mounts;
g. raising the hoist enough to clear the engine from its mounts;
h. drawing the engine out through the frontal opening in the vehicle, while adjusting the leveler control or the hoist as necessary to pass any obstructions.

2. Apparatus for removing and replacing an engine from a front compartment in a van type vehicle, comprising
an engine plate for attachment to the front end of an engine in the vehicle,
a lifting adapter plate hinged to said engine plate to swing about a horizontal axis,
a lift adapter arm extending from said lift adapter plate and having means for connection to a hoist apparatus,
a level controller including an extendable and retractable shaft connected at one of its ends to said lift adapter arm and having its other end adapted to engage the frontal area of an engine at a location spaced vertically from an attached engine plate whereby an engine can be attached and handled through the lifting adapter arm, and the engine's tilt position is adjustable with respect to the lifting adapter arm.

3. Apparatus as defined in claim 2, wherein
said hinge attachment of said engine plate to said lift adapter plate includes a removable horizontally extending hinge pin.

4. Apparatus as defined in claim 2, wherein said lift adapter arm is constructed to fit telescopically onto a hoist arm and locked into position.

5. Apparatus as defined in claim 2, wherein said extendable and retractable shaft includes an adjustment ratchet mechanism which is rotatable in opposite directions to shorten and lengthen the shaft to adjust the angle at which the attached engine is fixed onto the lift adapter arm.
